(19) United States
(12) Patent Application Publication
(10) Pub. No.: US 2006/0026674 A1
(43) Pub. Date: Feb. 2, 2006

(54) Firewall port search system

(76) Inventor: Mark Kevin Ward, Phoenixville, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/039,255

(22) Filed: Jan. 20, 2005

Related U.S. Application Data
(60) Provisional application No. 60/598,138, filed on Aug. 2, 2004.

(51) Int. Cl. G06F 15/16

(52) U.S. Cl. 726/11

(57) ABSTRACT

A search system and user interface provides flexible and comprehensive search functions for searching Access Lists of multiple firewall databases for IP addresses and Ports in a networked computer system involving multiple servers and hosting executable applications in an Application Service Provider (ASP) environment, for example. A system identifies communication configuration characteristics of one or more firewalls. The system includes an acquisition processor for acquiring firewall communication data identifying, for at least one firewall, an IP address and a corresponding port supporting communication through the one or more firewalls. A repository stores the acquired firewall communication data. A search processor initiates a search of the repository for particular firewall communication data in response to user entered search criteria.

This is a non-provisional application of provisional application Ser. No. 60/598,138 by M. K. Ward filed Aug. 2, 2004.

### FIELD OF THE INVENTION

This invention concerns a system for providing a searchable repository of active firewall communication configuration characteristics.

### BACKGROUND INFORMATION

It is necessary to be able to determine the communication configuration settings of firewalls that are currently in effect in a networked computer system to support addition or removal of communication links through the firewalls. It is also necessary to be able to determine the existing communication configuration settings to support addition and removal of system servers and associated executable applications.

Firewall communication configuration settings are typically recorded in a configuration file and periodically copied to backup files, for example. Known systems search Firewall backup files in response to entry of search criteria and a user command. Existing systems provide limited and inefficient firewall communication setting search capabilities by typically supporting a limited search of an individual backup configuration file to find IP address and/or a firewall port matching user entered search criteria. The existing system search and user interface capabilities do not offer the flexible and comprehensive search functions desirable in a networked computer system involving multiple servers and hosting executable applications in an Application Service Provider (ASP) environment, for example. A system according to invention principles addresses these deficiencies and associated problems.

### SUMMARY OF THE INVENTION

A search system and user interface provides flexible and comprehensive search functions for determining firewall communication configuration settings in a networked computer system involving multiple servers and hosting executable applications in an Application Service Provider (ASP) environment, for example. A system identifies communication configuration characteristics of one or more firewalls. The system includes an acquisition processor for acquiring firewall communication data identifying, for at least one firewall, an IP address and a corresponding port supporting communication through the one or more firewalls. A repository stores the acquired firewall communication data. A search processor initiates a search of the repository for particular firewall communication data in response to user entered search criteria.

### BRIEF DESCRIPTION OF THE DRAWING

FIG. 1 shows a system determining communication configuration characteristics of one or more firewalls, according to invention principles.

FIG. 2 shows a flowchart of a process for acquiring firewall communication configuration information for collation in a searchable repository, according to invention principles.

FIG. 3 shows a folder containing multiple backup Firewall configuration files for multiple corresponding firewalls in a networked computer system, according to invention principles.

FIG. 4 shows a firewall configuration table stored in an SQL server, according to invention principles.

FIG. 5 shows user interface display elements enabling user entry of search criteria supporting search of firewall configuration data, according to invention principles.

FIG. 6 shows results of a search of firewall configuration data based on search criteria including port and IP address identifiers, according to invention principles.

FIG. 7 illustrates IP address range masks, according to invention principles.

FIG. 8 shows a flowchart of a process for managing communication configuration characteristics of one or more firewalls, according to invention principles.

### DETAILED DESCRIPTION OF INVENTION

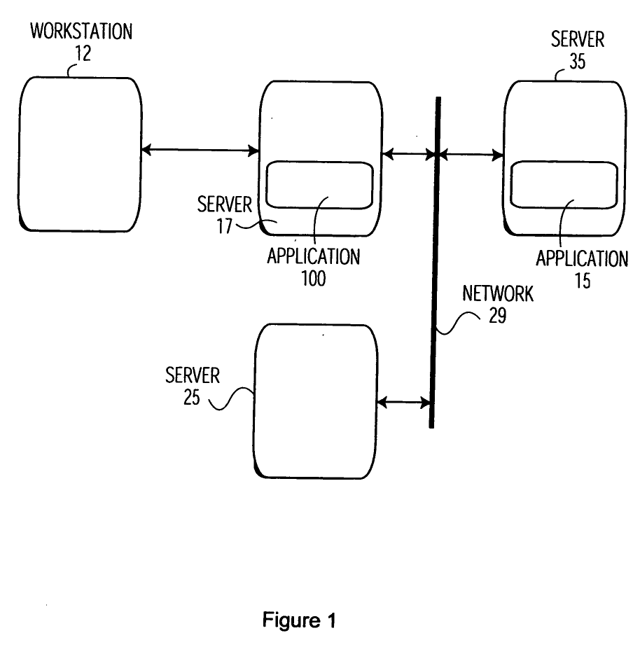

FIG. 1 shows a system determining communication configuration characteristics of one or more firewalls in a networked computer system. Executable application 15 operating on server 35 compiles communication configuration data of multiple different firewalls for storage in a repository within server 35. Application 15 compiles the configuration data from one or more servers such as server 25 via network 29 (such as a Local Area Network (LAN). A user employs workstation 12 in initiating a search for particular firewall configuration data in server 35 based on user entered search criteria. The system enables a user employing workstation 12 to search multiple firewall configuration files to find specific IP Addresses and Ports that are open in the firewalls. Application 100 operating on server 17, initiates generation of an Active Server Page (ASP) on workstation 12, which prompts for an IP Address and/or TCP port. The IP Addresses are searchable by 1^{st} octet, 1^{st} & 2^{nd} Octet, 1^{st} & 2^{nd} & 3^{rd} Octet or full 4 Octet IP address, for example. Application 100 supports searching compiled configuration data in a repository in server 35 for exact IP address matches and also for matches within predetermined masked address ranges. Similarly, application 100 supports searching compiled configuration data in a repository in server 35 for exact TCP Port matches and also matches within predetermined port ranges.

An executable application as used herein comprises code or machine readable instruction for implementing predetermined functions including those of an operating system, healthcare information system or other information processing system, for example, in response user command or input. Further, the processes performed by executable Applications 15 and 100 herein may be performed in other embodiments by a single application or multiple applications. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device.

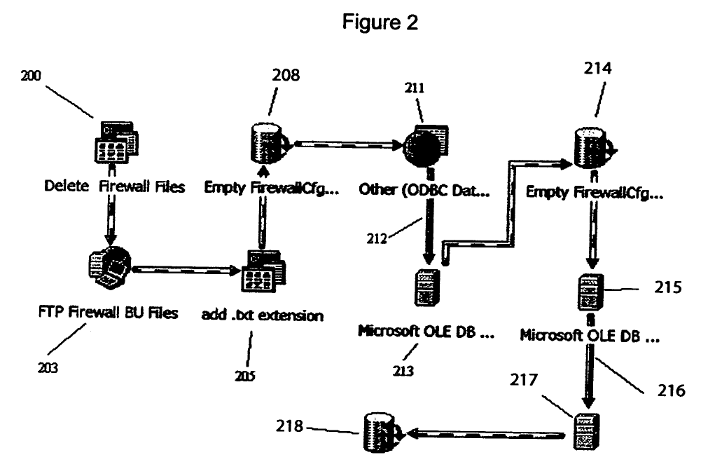

FIG. 2 shows a flowchart of a process employed by application 15 for acquiring firewall communication configuration information for collation in a searchable repository. In response to a detected change being made to a firewall such as the opening of a new port or closing of an existing port through a firewall, for example, a configuration file is backed up (copied) to a shared file on server 25 such as a Citrix compatible server. A configuration file is also backed up to a shared file on server 25 in response to other conditions such as, intermittently at a predetermined frequency or in response to user command, for example. Application 15 may comprise a Microsoft SQL Data Transformation Service (DTS) Package, for example, that is used to retrieve selected records from backup files and place them in a SQL server file in a repository on server 35 for processing by search functions of Application 100. In an alternative embodiment Application 15 comprises a different implementation used to retrieve the selected records from backup files and place them in a SQL server file in a repository on server 35. In step 200 of FIG. 2, Application 15 deletes backup Firewall configuration files from a repository on SQL server 35. Application 15 in step 203 copies backup Firewall configuration files from server 25 to a repository in SQL server 35 and in step 205 adds a file extension of “.txt” to individual filenames of the Firewall configuration files stored on server 35.

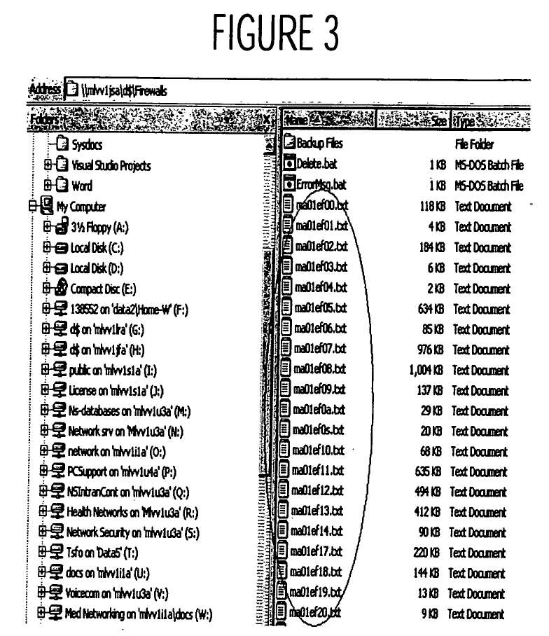

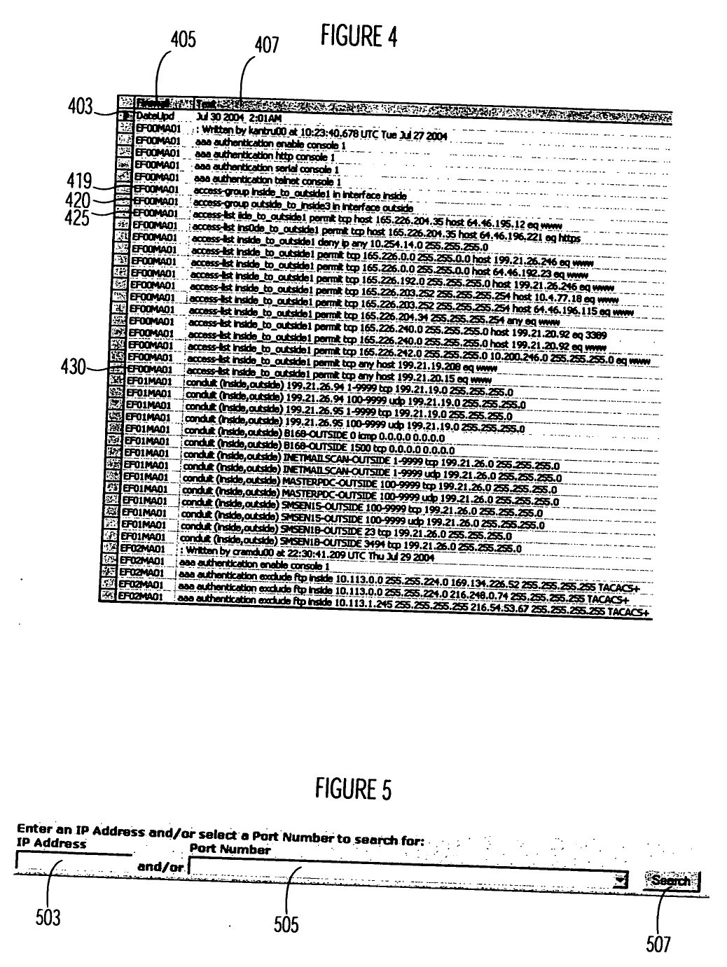

FIG. 3 shows a folder in a repository in SQL server 35. The folder contains multiple backup Firewall configuration files for multiple corresponding firewalls in a networked computer system. The filenames include a “.txt” filename extension. The filename of an individual file indicates the firewall name. In step 208 (FIG. 2) Application 15 deletes records in an SQL firewall configuration (FirewallConfigsBU) table in a repository on server 35. Application 15 in step 211 establishes an ODBC (Open DataBase Connectivity) connection to access the Firewall Configuration .txt files. An Open DataBase Connectivity connection is a Microsoft standard compatible connection for accessing different database systems from Windows, for instance Oracle or SQL. Application 15 in step 212 identifies and copies particular records from the Firewall backup files on server 35 to the SQL FirewallConfigsBU table also on server 35 to create a new FirewallConfigsBU table. Application 15 in step 213 establishes an OLE (Object Linking and Embedding) connection to the SQL firewall configuration (FirewallConfigsBU) table in a repository on server 35. An OLE connection employs an object system created by Microsoft. An OLE connection enables a user to invoke different editor components to create a compound document. The particular records copied from the Firewall backup files to the SQL FirewallConfigsBU table are records indicating open ports, associated IP address and other configuration information of firewalls. The particular records copied from the Firewall backup files to the SQL FirewallConfigsBU table are identified by initial text in the records (or by identification of other record characteristics) such as “: Written by”, “access-group”, “access-list”, “aaa authentication” or “conduit” (shown in FirewallConfigs table of FIG. 4), or other predetermined text, for example. In step 214 Application 15 deletes records in an SQL firewall configuration (FirewallConfigs) table in a repository on server 35. Application 15 in step 215 establishes an OLE (Object Linking and Embedding) connection to the SQL firewall configuration (FirewallConfigsBU) table in a repository on server 35. Application 15 in step 216 copies the SQL FirewallConfigsBU table on server 35 to the SQL FirewallConfigs table also on server 35 to create a new FirewallConfigs table. Application 15 in step 217 establishes an OLE (Object Linking and Embedding) connection to the SQL firewall configuration (FirewallConfigs) table in a repository on server 35. Application 15 in step 218 incorporates a Date/Time stamp in the FirewallConfigs table to record when the FirewallConfigs table is created or updated. Application 15 is scheduled to run daily to keep the FirewallConfigs table on server 35 up to date. In other embodiments Application 15 may run at different intervals as a background process, for example, or in response to user command.

FIG. 4 shows a FirewallConfigs table stored on SQL server 35. Row 403 shows a Date/Time stamp when the FirewallConfigs table is created or updated. Column 405 includes individual firewall identifiers for associated corresponding firewall configuration data presented in records of column 407. The FirewallConfigs table is compiled from firewall configuration data of multiple different firewalls that are employed on a network. The records of column 407 indicate open ports and associated IP addresses and IP address ranges and other information of associated firewalls. The particular records in column 407 include initial text used for record identification and copying (including “: Written by”, “access-group”, “access-list”, “aaa authentication” or “conduit”, for example).

FIG. 5 shows user interface display elements enabling user entry of search criteria supporting search of firewall configuration data by application 100 (FIG. 1). A user is able to enter an IP Address in data entry box 503 and/or a Port Number in data entry box 505. A search is initiated by Application 100 (FIG. 1) of compiled firewall configuration data in the FirewallConfigs table stored in a repository in SQL server 35 in response to user selection of button 507. If both an IP Address is entered in data entry box 503 and a Port Number is entered in data entry box 505, Application 100 needs to find both items associated with a record in the FirewallConfigs table in order for the record to be accessed and displayed to a user on workstation 12. Application 100 searches particular records with user predetermined initial text elements. Such initial text elements include “access-list”, “aaa authentication” and “conduit” in the FirewallConfigs table of FIG. 4. Application 100 searches for IP Address and Port Numbers matching entries made via boxes 503 (FIG. 5) and box 505. In conducting a search, Application 100 searches to find an IP address and Port number in access-list records in an associated access-group (i.e., in records immediately succeeding access-group records) in column 407 (FIG. 4) of a particular firewall identified by an identifier in column 405. For example, Application 100 searches to find an IP address and Port number in access-list records between row 430 and 425 for a corresponding access group identified in rows 419 and 420. In another embodiment Application 100 searches for IP Address and Port Numbers in a plurality of different FirewallConfigs tables in one or more distributed repositories accessible via network 29 (FIG. 1).

An IP Address is a unique identifying number for each device on a network. A typical IP Address would be 64.46.194.64 and each of the four numbers is called an octet. The term octet comes from the fact that each number of the IP Address, when displayed in binary format (01000000.00101110.11000010.010000 instead of 64.46.194.64) has eight digits. A Port indicates the service trying to be accessed by a connection through a firewall. Port Numbers and Port Names are both found within the FirewallConfigs table records in column 407 stored on SQL server 35. Application 100 employs a port number to port name cross-reference table to facilitate searches of the FirewallConfigs table in response to a port number or port name entered by a user via the FIG. 5 user interface. The port number to port name cross-reference table is stored in SQL server 35.

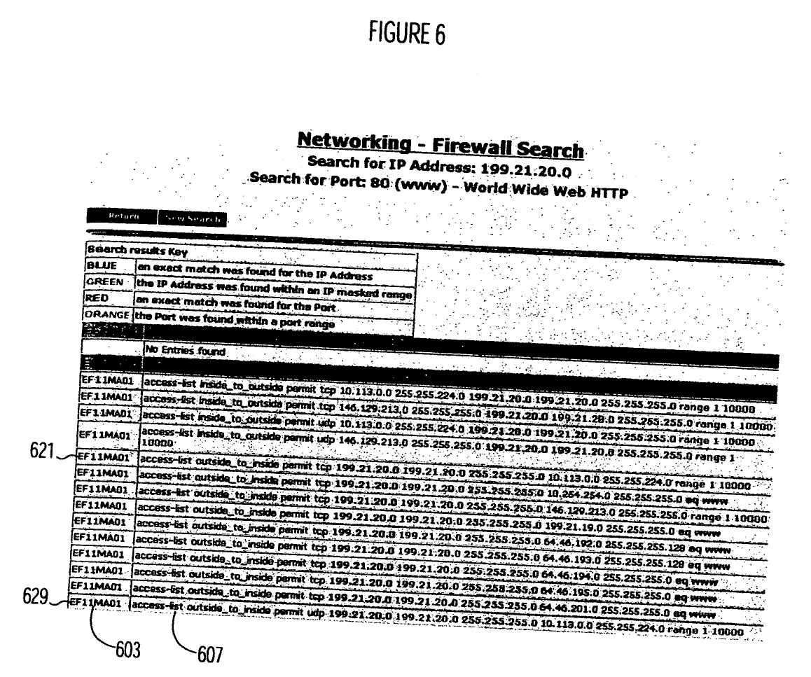

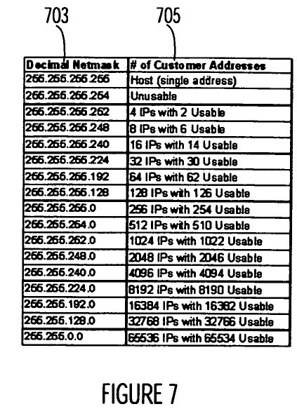

FIG. 6 shows results of a search of firewall configuration data based on search criteria including port and IP address identifiers. Specifically, FIG. 6 shows results of a search by Application 100 of a FirewallConfigs table for a particular IP address (199.21.20.0) and port 80 (world wide web). The search results show resultant records in column 607 for a particular access-list of a particular firewall having an identifier EF11MA01 shown in column 603. A user is able to enter an IP Address in data entry box 503 (FIG. 5) in the format of 1^{st}, 1^{st} & 2^{nd}, 1^{st}, 2^{nd} & 3^{rd} or all 4 Octets of an IP address and initiate a search by Application 100 (FIG. 1) of compiled firewall configuration data in the FirewallConfigs table stored on SQL server 35 in response to user selection of button 507 (FIG. 5). Application 100 searches IP addresses in the FirewallConfigs table for both exact matches and matches within masked ranges (IP Address with a subnet mask). A subnet mask or netmask indicates that the IP address/subnet mask combination represents a range of addresses as shown in FIG. 7.

FIG. 7 illustrates IP address range masks indicating IP addresses accessible through a firewall. Specifically, column 703 lists IP address decimal netmasks and column 705 indicates corresponding numbers of IP addresses and numbers of usable IP addresses that are accessible through an associated firewall. As an example, in the search results tabulated in FIG. 6, an IP address/subnet mask combination of 199.21.20.0 255.255.255.0 occurs in multiple search result records in column 607 between rows 621-629. This means that the IP address range concerned is 199.21.20.XXX where XXX is any number from 1 to 254. In response to user entry of a Port Number via the user interface display of FIG. 5, for example, Application 100 searches for as an exact match (by both Port Name and Port Number) and also as a match within a Port Range.

A user entered port name found within the records of column 407 of the FIG. 4 FirewallConfigs table is converted to a port number for processing, using the port number/name cross-reference table in the SQL server 35 database. For example, in the search results tabulated in FIG. 6, Application 100 finds port “www” and converts this name to port 80, thereby obtaining a match. Application 100 searches the FIG. 4 FirewallConfigs table and determines firewall configuration data that needs to be removed from the FirewallConfigs table when a server is de-installed. Application 100 does this automatically in response to detection of server de-installation determined from a change firewall configuration data or in response to user command, for example.

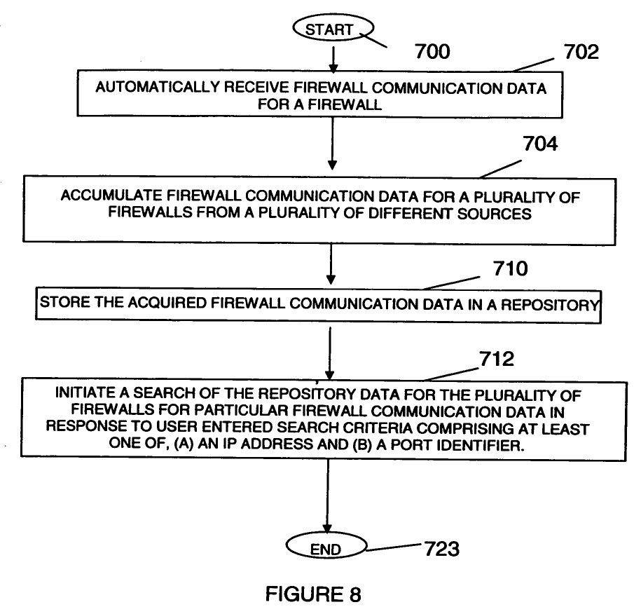

FIG. 8 shows a flowchart of a process performed by Application 15 in conjunction with Application 100 for managing communication configuration characteristics of one or more firewalls. In step 702, following the start at step 700, Application 15 automatically receives firewall communication data for a firewall in response to detection of a change in firewall configuration or in response to interrogation of a firewall configuration data managing application. In another embodiment, Application 15 automatically receives firewall communication at predetermined times. In step 704, Application 15 accumulates firewall communication data for multiple firewalls from multiple different sources. The multiple different sources comprise backup files, other configuration data repositories or configuration data maintained by a processing device such as a server, for example. The accumulated firewall communication data is used to identify an IP address and a corresponding port supporting communication through a firewall of the multiple firewalls. In step 710, Application 15 stores the acquired firewall communication data in a central repository (e.g., a database) comprising an SQL firewall configuration (FirewallConfigs) table in a repository on server 35. In another embodiment, Application 15 stores the acquired firewall communication data in multiple distributed repositories.

In step 712, Application 100 initiates a search of the repository data (FirewallConfigs table) for multiple firewalls for particular firewall communication data in response to user entered search criteria comprising at least one of, (a) an IP address, (b) a port identifier and (c) a range of IP addresses. A port identifier comprises a name, a number or a character string, for example. Application 100 uses a cross-reference map for translating between a port name and a port number (or character string) in identifying matching firewall configuration data in the search of the repository. The cross-reference map associates a port name with a corresponding port number (or character string) and is stored in a database table in server 35, for example. The process of FIG. 8 ends at step 723.

The system and processes presented in FIGS. 1-8 are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the systems and process of FIGS. 1-8 may be implemented in hardware, software or a combination of both.

What is claimed is:

1. A system for identifying communication configuration characteristics of at least one firewall, comprising:
an acquisition processor for acquiring firewall communication data identifying, for at least one firewall,
an IP address and
a corresponding port supporting communication through said at least one firewall;
a repository for storing said acquired firewall communication data; and
a search processor for initiating a search of said repository for particular firewall communication data in response to user entered search criteria.

2. A system according to claim 1, wherein
said acquisition processor acquires said firewall communication data for a plurality of firewalls,
said repository is a central repository storing said acquired firewall communication data for said plurality of firewalls and
said search processor initiates a search of said repository data for said plurality of firewalls for particular firewall communication data in response to user entered search criteria.

3. A system according to claim 1, wherein
said acquisition processor automatically receives firewall communication data for a firewall in response to detection of a change in firewall configuration.

4. A system according to claim 3, wherein
said acquisition processor automatically receives firewall communication data for a firewall at predetermined times.

5. A system according to claim 1, wherein
said acquisition processor automatically receives firewall communication data for a firewall in response to polling of a firewall configuration data managing application.

6. A system according to claim 1, wherein
said repository comprises a plurality of distributed databases and
said search processor initiates a search of said distributed databases for particular firewall communication data in response to user entered search criteria.

7. A system according to claim 1, wherein
said acquisition processor accumulates said firewall communication data for a plurality of firewalls from a plurality of different sources.

8. A system according to claim 7, wherein
said plurality of different sources comprise a plurality of different backup files.

9. A system according to claim 7, wherein
said search processor initiates a search of said repository data for said plurality of firewalls for particular firewall communication data in response to user entered search criteria comprising at least one of, (a) an IP address and (b) a port identifier.

10. A system according to claim 9, wherein
said port identifier comprises at least one of, (a) a name, (b) a number and (c) a character string and including
a cross-reference map for translating between said port name and said port number or character string in identifying matching firewall configuration data in said search of said repository.

11. A system according to claim 7, wherein
said search processor initiates a search of said repository data for said plurality of firewalls for particular firewall communication data in response to user entered search criteria comprising a range of IP addresses.

12. A system according to claim 1, including
a data processor for automatically updating said acquired firewall communication in said repository in response to detected de-installation of at least one of, (a) a server and (b) an executable application.

13. A system for identifying communication configuration characteristics of a plurality of firewalls in a network, comprising:
an acquisition processor for accumulating firewall communication data for a plurality of firewalls from a plurality of different sources, said firewall communication data identifying, for a plurality of firewalls,
an IP address and
a corresponding port supporting communication through a firewall of said plurality of firewalls;
a repository for storing said acquired firewall communication data; and
a search processor for initiating a search of said repository data for said plurality of firewalls for particular firewall communication data in response to user entered search criteria comprising at least one of, (a) an IP address and (b) a port identifier.

14. A method for identifying communication configuration characteristics of a plurality of firewalls in a network, comprising the activities of:
receiving firewall communication data identifying, for a plurality of firewalls,
an IP address and
a corresponding port supporting communication through a firewall of said plurality of firewalls;
storing said acquired firewall communication data in a repository; and
initiating a search of said repository for particular firewall communication data in response to user entered search criteria.
